(19) United States
(12) Patent Application Publication
(10) Pub. No.: US 2026/0131961 A1
(43) Pub. Date: May 14, 2026

(54) PACKAGING CONTAINER FOR SHIPPING PACKING GROUP II AND III DANGEROUS GOODS

(71) Applicant: ADS BIOTEC INC., Omaha, NE (US)

(72) Inventors: Scott Goodman, Blair, NE (US); Brandon Lingenfelter, Omaha, NE (US); Eric Barnhart, Lincoln, NE (US)

(73) Assignee: ADS BIOTEC INC., Omaha, NE (US)

(21) Appl. No.: 18/945,099

(22) Filed: Nov. 12, 2024

(51) Int. Cl. B65D 77/06; A61J 1/10; A61J 1/16; B65D 5/50; B65D 85/00

(52) U.S. Cl. CPC B65D 77/062; A61J 1/10; A61J 1/16; B65D 5/5038; B65D 85/70

(57) ABSTRACT

A combination packaging that is certified for shipping dangerous goods via marine or ground transportation, where the combination packaging only utilizes a readily recyclable fiberboard material and flexible plastic material as components of the combination packaging that contain the dangerous good (e.g. not including a dispenser when present). The combination packaging includes an outer packaging, two or more intermediate packagings, an inner packaging. The combination packaging provides increased efficiency in shipping volume (as compared to a conventional combination packaging having rigid inner packagings). The combination packaging also provides increased environmental efficiency (as compared to conventional combination packaging having metal or non-cyclable components) as both the outer packaging and at least one intermediate packaging are readily recyclable.

### BACKGROUND

Shipping dangerous goods is highly regulated by various governmental regulations. Shipping these dangerous goods requires, among other conditions, adhering to requirements for the packaging of the dangerous goods. For example, in the United States, shipping dangerous goods in Packing Group II (medium danger materials) or Packing Group III (minor danger materials) (as defined in 49 C.F.R. § 171.8 or its successor regulation), requires packing materials to be certified against certain defined testing standards, including the Cobb test, drop test, stacking test, and vibration test.

Conventional packaging for transport of dangerous goods that are liquids include placing the liquids in a rigid inner packaging (e.g. glass, inflexible plastic, or metal), placing this rigid inner packaging within a receptacle that is capable of containing the liquid if the rigid inner packaging leaks (e.g. a flexible plastic receptacle). The rigid inner packaging and receptacle (e.g. secondary containment) are then packaged in an intermediate packaging to reduce shifting and jostling of the rigid container during transport (e.g. a pulp pod), which is then all placed in an outer packaging. This conventional combination packaging includes four separate packaging articles (rigid inner packaging, receptacle, intermediate packaging, and outer packaging), with the drawback of the rigid inner packaging holding a predetermined volume of the dangerous good and the rigid container taking up a predetermined volume of space regardless of the physical volume of the contained liquid dangerous good.

Other conventional packaging for transport of dangerous goods that are liquid include placing the liquids in a rigid inner packaging, surrounding the rigid inner packaging with an adsorbent material that is capable of adsorbing the liquid if the rigid container leaks (e.g. vermiculite). The rigid inner packaging and adsorbent material are then further placed within a plastic liner for secondary containment, which is then all placed in an outer packaging. This conventional combination packaging includes four separate packaging articles (rigid inner packaging, adsorbent material, plastic liner as secondary containment, and an outer packaging), with the drawback of the adsorbent material being a nuisance for the end use customer both from a cleanliness of the inner packaging for the environment in which the transported liquid is to be used, and for its disposal following end of the transport. Further, the rigid inner packaging holding a predetermined volume of the dangerous good and the rigid container taking up a predetermined volume of space regardless of the volume of the dangerous good it contains.

The conventional packaging for shipping dangerous goods may require the dangerous good to be transferred from the rigid inner packaging to another container that the dangerous good will be dispensed from for use. This requires additional time and materials, as well as increased risk of bodily harm or loss of dangerous goods, and the potential for contamination of the transported liquid in connection with the transfer to the dispensing container.

It is therefore desirable to have an inner packaging for transport of dangerous goods that does not use a rigid inner packaging and rather uses a flexible container as the inner packaging for the dangerous goods for shipment. It is further desirable for the combination packaging to limit the number of component materials and maximize the recyclability of the component materials to increase efficiency in packaging the dangerous goods, while both meeting transport requirements and reducing the environmental impact of the combination packaging. Finally, it is desirable for the flexible inner packaging of the combination packaging to dispense the dangerous good for use without transfer to a different container nor to clean it of adsorbent material.

### SUMMARY

In aspects, combination packaging for the shipment of dangerous goods that are liquid via ground and marine transportation, the combination packaging including an outer packaging, the outer packaging being a cuboid shape and made of a recyclable fiberboard material and having a length, a width, and a height to contain at least two intermediate packagings; the least two intermediate packagings being a cuboid shape without a top and made of a recyclable fiberboard material and having a length, a width, and a height to contain an inner packaging, wherein the at least two intermediate packagings are contained in the outer packaging where the at least two inner packagings are stacked and do not move vertically when the outer packaging is sealed; the inner packaging being made of a flexible plastic material that is chemically stable and non-reactive with the dangerous good.

The combination packaging of paragraph [0006], further including a second inner packaging, the second inner packaging being made of a flexible plastic material, wherein, the second inner packaging contains the inner packaging.

The combination packaging of paragraph [0007], further including a second second inner packaging, the second second inner packagings being made of a flexible plastic material, wherein, the second second inner packaging contains the first inner packaging and the inner packaging.

The combination packaging of paragraph [0006], wherein the inner packaging has a dispenser to dispense the dangerous good upon completion of transportation.

The combination packaging of paragraph [0006], wherein the maximum volume of dangerous goods that may be transported in the combination packaging is from 9 to 40 liters.

The combination packaging of paragraph [0006], wherein there are three intermediate packagings, the intermediate packagings each containing three inner packagings of 1 liter maximum volume.

The combination packaging of paragraph [0006], wherein there are three intermediate packagings, the intermediate packagings each containing two inner packagings of 2 liter maximum volume.

The combination packaging of paragraph [0006], wherein there are three intermediate packagings, the intermediate packagings each containing two inner packagings of 5 liter maximum volume.

The combination packaging of paragraph [0006], wherein there are two intermediate packagings, the intermediate packagings each containing two inner packagings of 10 liter maximum volume.

In aspects, combination packaging for the shipment of dangerous goods that are liquid via ground and marine transportation, the combination packaging including an outer packaging, the outer packaging being a cuboid shape and made of a recyclable fiberboard material and having a length, a width, and a height to contain at least two intermediate packagings; the least two intermediate packagings being a cuboid shape without a top and made of a recyclable fiberboard material, and having a length, a width, and a height to contain an inner packaging, the at least two intermediate packagings including reinforced corners formed from the recyclable fiberboard material, wherein the at least two intermediate packagings are contained in the outer packaging where the at least two inner packagings are stacked and do not move vertically when the outer packaging is sealed; the inner packaging being made of a flexible plastic material that is chemically stable and non-reactive with the dangerous good.

The combination packaging of paragraph [00015], further including a second inner packaging, the second inner packaging being made of a flexible plastic material, wherein, the second inner packaging contains the inner packaging.

The combination packaging of paragraph [0016], further including a second second inner packaging, the second second inner packagings being made of a flexible plastic material, wherein, the second second inner packaging contains the first inner packaging and the inner packaging.

The combination packaging of paragraph [0015], wherein the inner packaging has a dispenser to dispense the dangerous good upon completion of transportation.

The combination packaging of paragraph [0015], wherein the maximum volume of dangerous goods that may be transported in the combination packaging is from 9 to 40 liters.

In aspects, combination packaging for the shipment of dangerous goods that are liquid, the combination packaging including an outer packaging, the outer packaging being a cuboid shape and made of a recyclable fiberboard material and having a length, a width, and a height to contain at least two intermediate packagings; the least two intermediate packagings being a cuboid shape without a top and made of a recyclable fiberboard material, and having a length, a width, and a height to contain an inner packaging, the at least two intermediate packagings including reinforced corners formed from the recyclable fiberboard material, wherein the at least two intermediate packagings are contained in the outer packaging where the at least two inner packagings are stacked and do not move vertically when the outer packaging is sealed; and the inner packaging being made of a flexible plastic material that is chemically stable and non-reactive with the dangerous good, wherein the combination packaging is certified for the shipping of dangerous goods of packing group II and packing group III designations under United States law.

The combination packaging of paragraph [0020], further comprising a second inner packaging, the second inner packaging being made of a flexible plastic material, wherein, the second inner packaging contains the inner packaging.

The combination packaging of paragraph [0021], further comprising a second second inner packaging, the second second inner packagings being made of a flexible plastic material, wherein, the second second inner packaging contains the first inner packaging and the inner packaging.

The combination packaging of paragraph [0020], wherein the inner packaging has a dispenser to dispense the dangerous good upon completion of transportation.

The combination packaging of paragraph [0020], wherein the maximum volume of dangerous goods that may be transported in the combination packaging is from 9 to 40 liters.

The combination packaging of paragraph [0020], wherein the inner packaging is a medical grade intravenous bag of polyvinyl chloride.

The combination packaging of paragraph [0006], wherein the there are two intermediate packagings, the intermediate packagings each containing one inner packagings of 20 liter maximum volume.

### BRIEF DESCRIPTION OF FIGURES

FIG. 1 is a perspective view of the combination packaging.

FIG. 2a is an intermediate packaging that is flat.

FIG. 2b is an intermediate packaging that is constructed.

FIG. 2c is intermediate packaging that is stacked and shows an interior of the intermediate packaging.

FIG. 3 is a flexible intermediate packaging having two second inner packagings surrounding the intermediate packaging to provide leak protection a dust-barrier.

FIG. 4a is an outer packaging that is flat.

FIG. 4b is an outer packaging that is constructed.

### DETAILED DESCRIPTION

As used herein, the following terms have the meanings ascribed to them:

“Dangerous goods” means those goods that are medium danger and minor danger as assigned by Packing Group II and Packing Group III designations pursuant to the applicable federal law regulations of the United States (as of the date of filing 49 C.F.R. §§ 171.8; 172.101 et seq.)

“Non-bulk packaging” means packing that is assigned the status of non-bulk packaging pursuant to the applicable federal law and regulations of the United States (as of the date of filing 49 C.F.R. § 171.8)

“Certified” means non-bulk packaging for dangerous goods that meets the certification requirements of applicable federal law and regulations of the United States (as of the date of filing 49 C.F.R. §§ 178.600 et seq.).

“Readily recyclable” means a material that is recyclable and is not petroleum or metal based.

A combination packaging 100 that is certified for shipping dangerous goods via marine or ground transportation, where the combination packaging only utilizes a readily recyclable fiberboard material and flexible plastic material as components of the combination packaging that contain the dangerous good (e.g. not including a dispenser 112 when present). The combination packaging 100 includes an outer packaging 102, two or more intermediate packagings 104, an inner packaging 110. The combination packaging 100 may contain one or more second intermediate packagings 108 that provide leak protection and a dust-barrier to the intermediate packaging 104. The inner packaging 110 of the combination packaging may include a connected dispenser 112. The combination packaging 100 provides increased efficiency in shipping volume (as compared to a conventional combination packaging having rigid inner packagings) as the inner packaging 110 only occupies a space slightly more than the volume of the dangerous goods (i.e. the volume of the dangerous goods plus the thickness of the inner packaging 110), to maximize the available interior space of the combination packaging 100 for transport. The combination packaging 100 also provides increased environmental efficiency (as compared to conventional combination packaging having metal or non-cyclable components) as both the outer packaging 102 and at least one intermediate packaging 104 are readily recyclable.

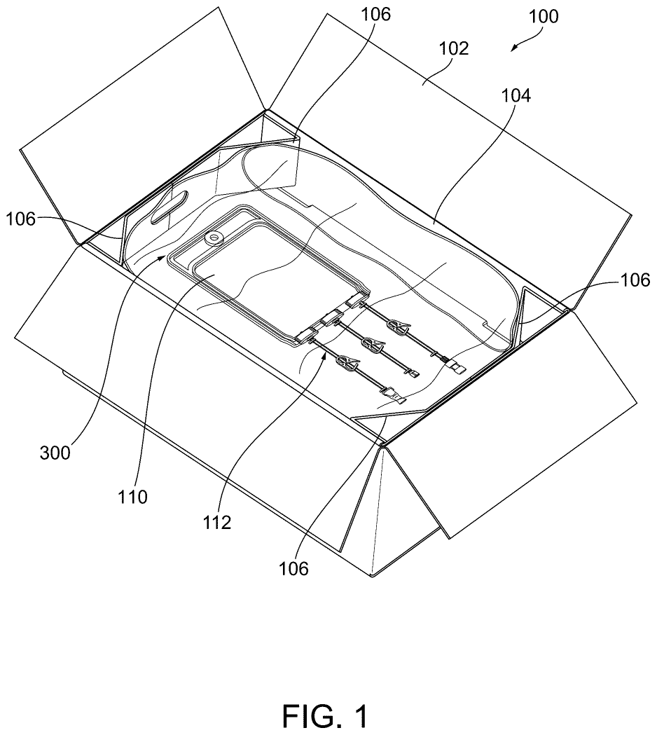

FIG. 1 is a perspective view of the combination packaging 100. The combination packaging 100 includes an outer packaging 102, at least two intermediate packagings 104, and flexible inner packaging 110 with having an second inner packaging 108. The combination packaging 100 is certified for transport of dangerous goods via marine or ground transportation. The combination packaging 100 may accommodate a volume of dangerous goods from 9 Liters (L) to 40 L when volume of the inner packagings 110 are fully utilized. The outer packaging 102 of the combination packaging 100 contains the at least two intermediate packagings 104 and at least one inner packaging 110, and may contain a second inner packaging 108, within the interior of the outer packaging 102. The two or more intermediate packagings 104 contain the inner packaging 110 and may contain a second inner packaging 108, where the inner packaging 110 and second inner packaging 108 reside in an interior of the two or more intermediate packagings 104.

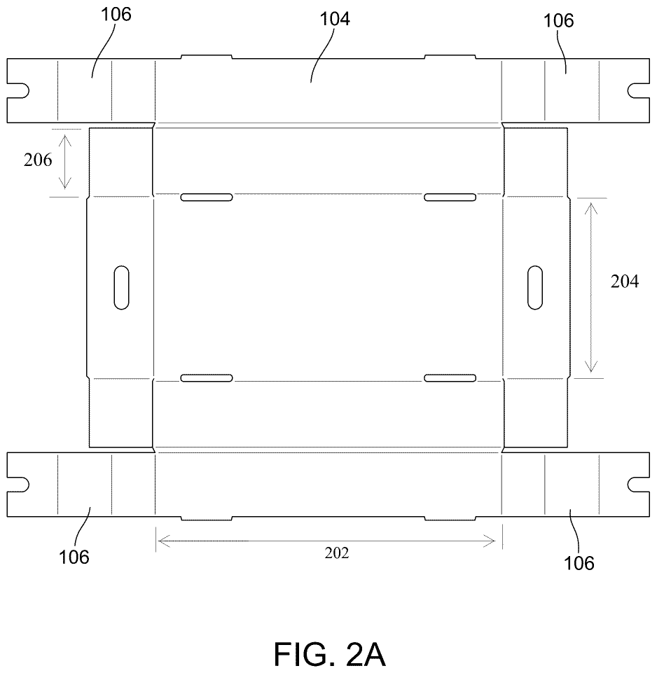

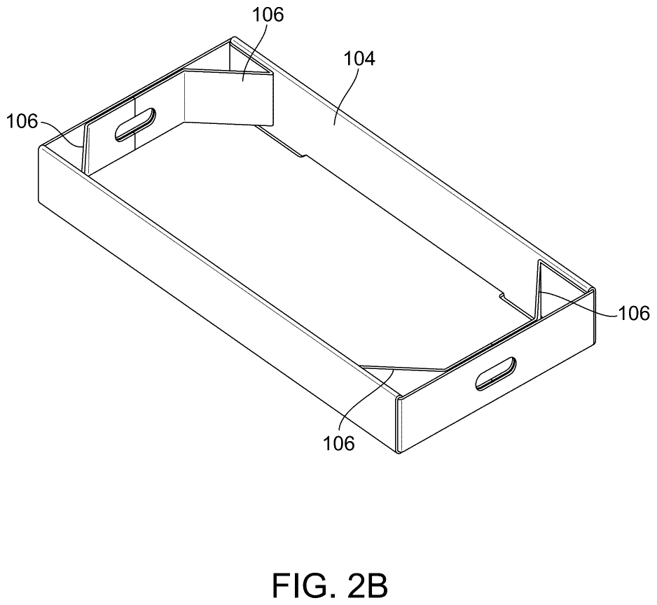

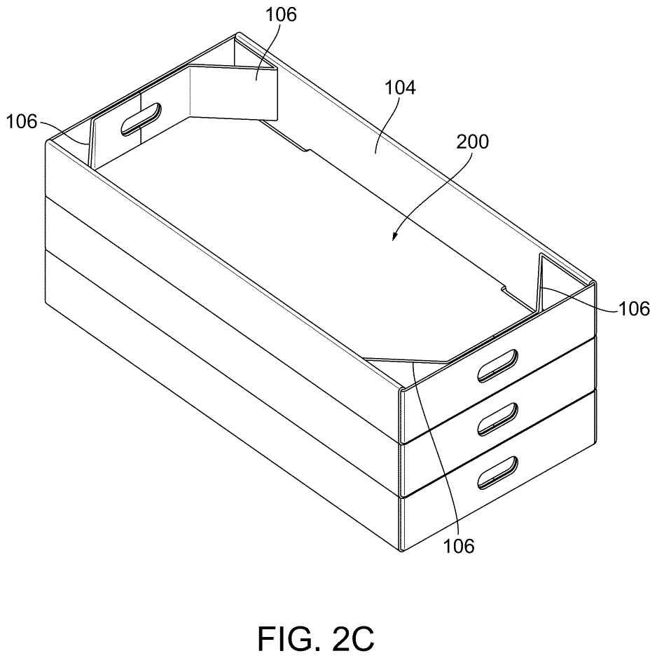

FIG. 2a represents an intermediate packaging 104 that is flat (i.e. pre-folding to construct). The at least two intermediate packagings 104 include reinforced corners 106 (see FIG. 2b) and an interior 200 (see FIG. 2c). The at least two intermediate packagings 104 are formed from a readily recyclable wood fiber-based material.

Each intermediate packaging 104 has a length 202 and a width 204 that allows each intermediate packaging 104 to reside within the outer container 102 without horizontal (i.e. side-to-side) movement when the combination packaging 100 is fully assembled. For example, when the outer packaging 102 is for transporting liquid volumes of a 1 L size, each intermediate packaging 104 has a width 204 of 30.64 centimeters (12 1/16 inches) and a length 202 of 61.44 centimeters (24 3/16 inches); when the outer packaging 102 is for transporting liquid volumes of a 2 L size, each intermediate packaging 104 as a width 204 of 30.64 centimeters (12 1/16 inches) and a length 202 of 76.78 centimeters (30 3/16 inches); when the outer packaging 102 is for transporting liquid volumes of a 5 L size, each intermediate packaging 104 as a width 204 of 38.26 centimeters (15 1/16 inches) and a length 202 of 61.44 centimeters (24 3/16 inches); when the outer packaging 102 is for transporting liquid volumes of a 10 L size, each intermediate packaging 104 as a width 204 of 63.66 centimeters (25 1/16 inches) and a length 202 of 63.98 centimeters (25 3/16 inches); when the outer packaging 102 is for transporting liquid volumes of a 20 L size, each intermediate packaging 104 as a width 204 of 56.04 centimeters (22 1/16 inches) and a length 202 of 56.36 centimeters (22 3/16 inches).

Each intermediate packaging 104 has a height that allows the intermediate packaging 104 to reside stacked (see FIG. 2c) within the outer packaging 102 without vertical (i.e. up-and-down) movement when the combination packaging 100 is fully assembled. For example, when the outer packaging 102 is for transporting liquid volumes of a 1 L size, there are three intermediate packagings 104 with each intermediate packaging 104 having a height 206 of 11.59 centimeters (4 9/16 inches); when the outer packaging 102 is for transporting liquid volumes of a 2 L size there are three intermediate packagings 104, with each intermediate packaging 104 having a height 206 of 11.59 centimeters (4 9/16 inches); when the outer packaging 102 is for transporting liquid volumes of a 5 L size there are three intermediate packagings 104, with each intermediate packaging 104 having a height 206 of 14.13 centimeters (5 9/16 inches); when the outer packaging 102 is for transporting liquid volumes of a 10 L size there are two intermediate packagings 104, with each intermediate packaging 104 having a height 206 of 16.99 centimeters (6 11/16 inches); when the outer packaging 102 is for transporting liquid volumes of a 20 L size there are two intermediate packagings 104, with each intermediate packaging 104 having a height 106 of 18.26 centimeters (7 3/16 inches). The height of the intermediate packaging 104 may vary directly proportionate (i.e. internal height plus the height of the material of the intermediate packaging 104) to the height of the reinforced corners 106 as set forth in FIG. 2b.

FIG. 2b represents an intermediate packaging 104 that is constructed. The constructed intermediate packaging 104 is a cuboid shape without a top, such that the interior 200 (see FIG. 2c) is not covered allowing the inner packaging 110 to reside within the interior 200 (see FIG. 2c). The reinforced corners 106 of the intermediate packaging 104 provide structural integrity to the packaging container 100, while providing adequate support to the inner packaging (110) (i.e. shifting and movement of the inner packaging does not compromise the dangerous good or combination packaging 100). Specifically, the reinforced corners contribute to the packaging container 100 meeting the certification standards associated with the drop test, stacking test, and vibration test. The reinforced corners 106 are formed from the intermediate packaging 104 and are triangular in shape. The reinforced corners 106 are formed from portions of the intermediate packaging 104 (as shown in FIG. 2a for the portions not included in the length 202 of the intermediate packaging 104).

The triangular corners 106 have a height that is equal to the internal height (height from the floor of the interior 200 to the top of the intermediate packaging 104) of the intermediate packaging 104. The height and length of each side (the two sides of the reinforced corner that are along the side of the intermediate packaging 104) of the reinforced corners 106 have the following tolerance ranges from the standard height and length:

| | | | Reinforced Corner 106 | | | |
|---|---|---|---|---|---|---|
| Liquid | | | Length | Height | Length | Height |
| Volume | | | (inch) | (inch) | (cm) | (cm) |
| 20 | L | Standard | 4″ | 7″ | 10.16 | 17.78 |
| | | Range | +2″/−2″ | +3″/−2″ | +5.08/−5.08 | +7.62/−5.08 |
| | | max | 6 | 10 | 15.24 | 25.4 |
| | | min | 2 | 5 | 5.08 | 12.7 |
| 10 | L | Standard | 5 ¾″ | 6 ½″ | 14.61 | 16.51 |
| | | Range | +3″/−2″ | +3″/−2″ | +7.62/−5.08 | +7.62/−5.08 |
| | | max | 8.75 | 9.5 | 22.23 | 8.89 |
| | | min | 3.75 | 4.5 | 9.53 | 11.43 |
| 5 | L | Standard | 3 ¾″ | 5 ½″ | 9.53 | 13.97 |
| | | Range | +1/−2″ | +4.5″/−2″ | +15.24/−12.7 | +11.43/−5.08 |
| | | max | 4.75 | 10 | 12.07 | 25.4 |
| | | min | 1.75 | 3.5 | 4.45 | 8.89 |
| 2 | L | Standard | 3 ½″ | 4 ½″ | 8.89 | 11.43 |
| | | Range | +½″/−2″ | +4″/−2″ | +15.24/−12.7 | +10.16/−5.08 |
| | | max | 3 | 8.5 | 7.62 | 21.59 |
| | | min | 1.5 | 2.5 | 3.81 | 6.35 |
| 1 | L | Standard | 3 ½″ | 4 ½″ | 8.89 | 11.43 |
| | | Range | +½″/−2″ | +4″/−1.5″ | +12.7/−10.16 | +10.16/−3.81 |
| | | max | 3 | 8.5 | 7.62 | 21.59 |
| | | min | 1.5 | 2.5 | 3.81 | 6.35 |

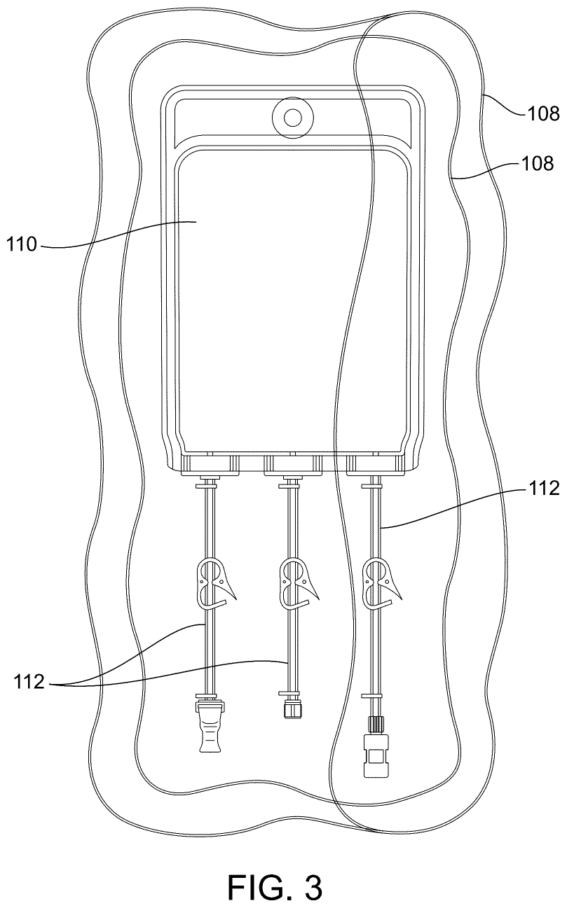

FIG. 3 represents the inner packaging 110 within the second inner packaging 108 of the combination packaging 100. The inner packaging 110 contains the dangerous goods. The inner packaging 110 is a flexible plastic material that is chemically stable (i.e. will not degrade during transportation) and non-reactive with the dangerous good. For example, the inner packaging 110 may be a medical grade intravenous bag (IV) of polyvinyl chloride (PVC). The inner packaging 110 may range in maximum volume capacity from 1 L to 20 L, which is dependent upon the at least two intermediate packagings 104 of the combination packaging 100. For example, when the combination packaging 100 has intermediate packagings 104 for transport of inner packagings 110 of the 1 L size, there are three inner packagings 110 per intermediate packaging 104 of 1 L maximum volume capacity; when the combination packaging 100 has intermediate packagings 104 for transport of inner packagings 110 of the 2 L size, there are two inner packagings 110 per intermediate packaging 104 of 2 L maximum volume capacity; when the combination packaging 100 has intermediate packagings 104 for transport of inner packagings 110 of the 5 L size, there are two inner packagings 110 per intermediate packaging 104 of 5 L maximum volume capacity; when the combination packaging 100 has intermediate packagings 104 for transport of inner packagings 110 of the 10 L size, there are two inner packagings 110 per intermediate packaging 104 of 10 L maximum volume capacity; when the combination packaging 100 has intermediate packagings 104 for transport of inner packagings 110 of the 20 L size, there is one inner packaging 110 per intermediate packaging 104 of 20 L maximum volume capacity.

The inner packaging 110 may transport the desired level of dangerous goods. The inner packaging 110 contributes to the combination packaging 100 obtaining certification by meeting the standards associated primarily with the Cobb test. The flexible nature of the inner packagings 110 allow shipment of more volume of dangerous goods per size of the outer packaging 102 as compared to conventional combination packaging having rigid inner packagings.

The inner packaging 110 may further include a dispenser 112. The dispenser includes lines of tubing with clamps that serve as ports to dispense the dangerous goods upon delivery for use. The dispenser 112 is of a material that is chemically stable and non-reactive with the dangerous goods. The dispenser 112 allows for use of the dangerous goods without transfer to a secondary dispensing container.

The combination packaging 100 may further include a second inner packagings 108. There may be more than one second inner packagings 108. The one or more second inner packagings 108 maintain staged cleanliness of the inner container 110 by fully encompassing the next closest second inner packaging 110 or inner packaging 110, such as for use in a clean room environment. If there are more than one second inner packagings 108, the second inner packagings 108 are bagged over each other. The second inner packagings 108 are made of a flexible plastic material.

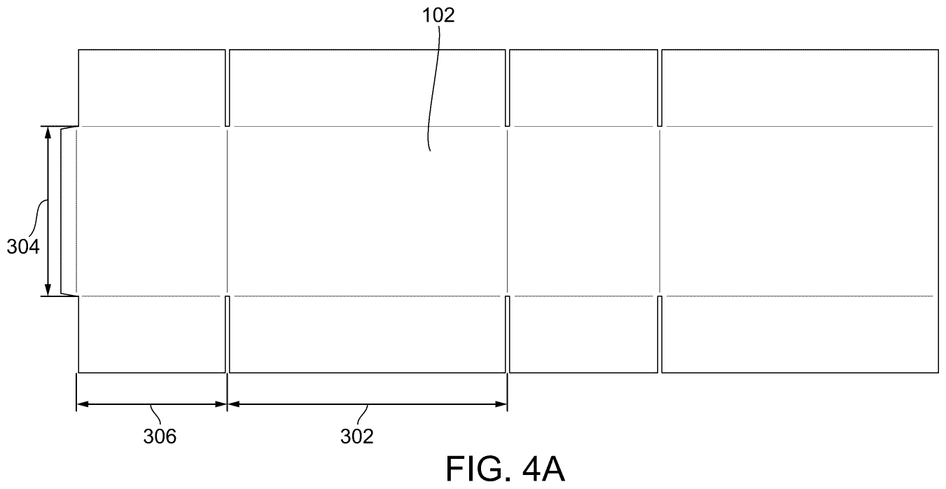

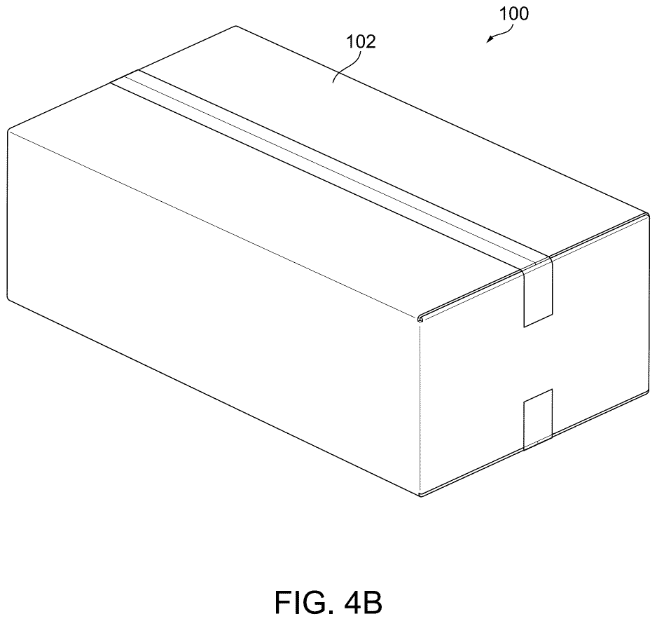

FIG. 4a represents an outer packaging 102 that is flat (i.e. pre-folding to construct). The outer packaging 102 is made of a readily recyclable material and has an interior 300 (see FIG. 3b). The outer packaging 102 may be a variety of sizes. For example, an outer packaging 102 for transport of size 1 L inner packaging(s) 110 has a length 302 of 63.34 centimeters (24 15/16 inches), height 304 of 38.42 centimeters (15⅛ inches) and a width 306 of 34.45 centimeters (13 9/16 inches); an outer packaging 102 for transport of 2 L size inner packaging(s) 110 has a length 302 of 78.43 centimeters (30⅞ inches), height 304 of 38.1 centimeters (15 inches) and a width 306 of 34.61 centimeters (13⅝ inches); an outer packaging 102 for transport of 5 L size inner packaging(s) 110 has a length 302 of 63.03 centimeters (24 13/16 inches), height 304 of 40.04 centimeters (18⅛ inches), and width 306 of 39.69 centimeters (15⅝ inches); an outer packaging 102 for transport of 10 L size inner packaging(s) 110 has a length 302 of 67.47 centimeters (26 9/16 inches), height 304 of 36.83 centimeters (14½ inches), and width 306 of 66.84 centimeters (26 5/16 inches); an outer packaging 102 for transport of 20 L size inner packaging has a length 302 of 59.85 centimeters (23 9/16 inches), a height 304 of 39.05 centimeters (15⅜ inches), and a width 306 of 58.58 centimeters (23 1/16 inches).

FIG. 4b represents a constructed outer packaging 102. The outer packaging 102 is cuboid in shape, including a top, such that when the combination packaging 100 is fully assembled the outer packaging 102 is sealed, such as with 48 millimeter pressure sensitive plastic tape. The at least two intermediate packagings 104 reside within the outer packaging 102 in a stacked arrangement (see FIG. 2c). The stacked arrangement creates sectioned compartments of the combination packaging 100, where a bottom of a first intermediate packaging 104 serves to constrain the inner packaging(s) 110 within the second inner packagings 108 of a second intermediate packaging 104 below the first intermediate packaging 104. The stacked arrangement and sectioned compartments minimize movement of the inner packaging(s) 110 in the inner packagings 104. This minimized movement contributes to the combination packaging 100 obtaining certification by meeting the standards associated with the drop test, stacking test, and vibration test. Further the minimized movement from these sectioned compartments allow shipment of the combination packaging 100 without all of the inner packagings 108 being full.

The combination packaging 100 described herein is also suitable for shipment of liquid non-dangerous goods via air, marine, or ground transportation.

1. Combination packaging for the shipment of dangerous goods that are liquid via ground and marine transportation, the combination packaging comprising:
an outer packaging, the outer packaging being a cuboid shape and made of a recyclable fiberboard material and having a length, a width, and a height to contain at least two intermediate packagings;
the least two intermediate packagings being a cuboid shape without a top and made of a recyclable fiberboard material and having a length, a width, and a height to contain an inner packaging, wherein
the at least two intermediate packagings are contained in the outer packaging where the at least two inner packagings are stacked and do not move vertically when the outer packaging is sealed;
the inner packaging being made of a flexible plastic material that is chemically stable and non-reactive with the dangerous good.

2. The combination packaging of claim 1, further comprising
a second inner packaging, the second inner packaging being made of a flexible plastic material, wherein,
the second inner packaging contains the inner packaging.

3. The combination packaging of claim 2, further comprising
a second second inner packaging, the second second inner packagings being made of a flexible plastic material, wherein,
the second second inner packaging contains the first inner packaging and the inner packaging.

4. The combination packaging of claim 1, wherein the inner packaging has a dispenser to dispense the dangerous good upon completion of transportation.

5. The combination packaging of claim 1, wherein the maximum volume of dangerous goods that may be transported in the combination packaging is from 9 to 40 liters.

6. The combination packaging of claim 1, wherein
there are three intermediate packagings, the intermediate packagings each containing three inner packagings of 1 liter maximum volume.

7. The combination packaging of claim 1, wherein
there are three intermediate packagings, the intermediate packagings each containing two inner packagings of 2 liter maximum volume.

8. The combination packaging of claim 1, wherein
there are three intermediate packagings, the intermediate packagings each containing two inner packagings of 5 liter maximum volume.

9. The combination packaging of claim 1, wherein
there are two intermediate packagings, the intermediate packagings each containing two inner packagings of 10 liter maximum volume.

10. The combination packaging of claim 1, wherein
there are two intermediate packagings, the intermediate packagings each containing one inner packagings of 20 liter maximum volume.

11. Combination packaging for the shipment of dangerous goods that are liquid via ground and marine transportation, the combination packaging comprising:
an outer packaging, the outer packaging being a cuboid shape and made of a recyclable fiberboard material and having a length, a width, and a height to contain at least two intermediate packagings;
the least two intermediate packagings being a cuboid shape without a top and made of a recyclable fiberboard material, and having a length, a width, and a height to contain an inner packaging, the at least two intermediate packagings including reinforced corners formed from the recyclable fiberboard material, wherein
the at least two intermediate packagings are contained in the outer packaging where the at least two inner packagings are stacked and do not move vertically when the outer packaging is sealed;
the inner packaging being made of a flexible plastic material that is chemically stable and non-reactive with the dangerous good.

12. The combination packaging of claim 11, further comprising
a second inner packaging, the second inner packaging being made of a flexible plastic material, wherein,
the second inner packaging contains the inner packaging.

13. The combination packaging of claim 12, further comprising
a second second inner packaging, the second second inner packagings being made of a flexible plastic material, wherein,
the second second inner packaging contains the first inner packaging and the inner packaging.

14. The combination packaging of claim 11, wherein the inner packaging has a dispenser to dispense the dangerous good upon completion of transportation.

15. The combination packaging of claim 11, wherein the maximum volume of dangerous goods that may be transported in the combination packaging is from 9 to 40 liters.

16. Combination packaging for the shipment of dangerous goods that are liquid, the combination packaging comprising:
an outer packaging, the outer packaging being a cuboid shape and made of a recyclable fiberboard material and having a length, a width, and a height to contain at least two intermediate packagings;
the least two intermediate packagings being a cuboid shape without a top and made of a recyclable fiberboard material, and having a length, a width, and a height to contain an inner packaging, the at least two intermediate packagings including reinforced corners formed from the recyclable fiberboard material, wherein
the at least two intermediate packagings are contained in the outer packaging where the at least two inner packagings are stacked and do not move vertically when the outer packaging is sealed; and
the inner packaging being made of a flexible plastic material that is chemically stable and non-reactive with the dangerous good, wherein
the combination packaging is certified for the shipping of dangerous goods of packing group II and packing group III designations under United States law.

17. The combination packaging of claim 16, further comprising
a second inner packaging, the second inner packaging being made of a flexible plastic material, wherein,
the second inner packaging contains the inner packaging.

18. The combination packaging of claim 17, further comprising
a second second inner packaging, the second second inner packagings being made of a flexible plastic material, wherein,
the second second inner packaging contains the first inner packaging and the inner packaging.

19. The combination packaging of claim 16, wherein the inner packaging has a dispenser to dispense the dangerous good upon completion of transportation.

20. The combination packaging of claim 16, wherein the maximum volume of dangerous goods that may be transported in the combination packaging is from 9 to 40 liters.

21. The combination packaging of claim 16, wherein the inner packaging is a medical grade intravenous bag of polyvinyl chloride.
